(19) United States
(12) Patent Application Publication
(10) Pub. No.: US 2022/0410952 A1
(43) Pub. Date: Dec. 29, 2022

(54) TRANSFER CART

(71) Applicant: Current Tools, Inc., Greenville, SC (US)

(72) Inventor: Heather Stone, Fletcher, NC (US)

(21) Appl. No.: 17/358,662

(22) Filed: Jun. 25, 2021

(51) Int. Cl. B62B 3/02; B21D 7/16

(52) U.S. Cl. CPC B62B 3/02; B21D 7/16; B62B 2206/06

(57) ABSTRACT

A cart and associated method of using the cart to transfer one or more components of a conduit bender is provided. The cart includes one or more caster wheels. A base platform coupled to the one or more caster wheels. A leg assembly extends between the base platform and a top platform. The top platform comprising a plurality of separator bars spaced apart and co-extending with one another such that a plurality of rows is defined between the plurality of separator bars. Each row of the plurality of rows being sized to receive the one or more components of the conduit bender. A plurality of rollers extending between neighboring separator bars in each row of the plurality of rows. The plurality of rollers rotatably coupled to the neighboring separator bars.

### FIELD

The present disclosure relates generally to carts for transferring one or more components of a conduit bender. Particularly, the present disclosure relates to carts capable of securing and transferring multiple components of a conduit bender simultaneously.

### BACKGROUND

Conventional tube bending devices (such as conduit benders) include means for rotationally drawing tubes along circular (or curved) arcs, which plastically deforms the tubes into having a corresponding curvature. Such tube bending devices may be manually operated or machine operated. For example, a manually operated tube bending device may include a shoe attached to a lever arm. One or more tubes may be coupled to the shoe, and a user can subsequently apply a force to the lever arm to plastically deform the tube into having a curve that corresponds with an arc in the shoe. In general, manually operated tube bending devices are only usable on smaller diameter tubes and may be undesirable due to the effort required by the user.

Machine operated benders are capable of bending larger diameter tubes without a user applied force. Such benders often include a shoe having a defined arc, a follow bar, and a hydraulic actuator. In operation, the large diameter tube may be coupled to the shoe and follow bar, and the hydraulic actuator may apply a force to plastically deform (or permanently bend) the tube around the shoe. Many machine operated benders include one or more interchangeable components (such as shoes and/or follow bars) depending on the size of the tube to be bent, desired curve radius, or other factors. For example, the shoe and follow bar having a first size may be removed from the machine operated bender and replaced with a shoe and follow bar having a second size. Such an operation may require the machine operator to physically remove and replace the shoe and follow bar, which can be tiresome due to the weight of the components.

As such, an improved device for assisting with the removal and replacement of one or more components of a machine operated bender is desired in the art.

### BRIEF DESCRIPTION

Aspects and advantages of the carts and associated methods in accordance with the present disclosure will be set forth in part in the following description, or may be obvious from the description, or may be learned through practice of the technology.

In accordance with one embodiment, a cart for transferring one or more components of a conduit bender is provided. The cart defines a longitudinal axis, a vertical axis, and a transverse axis. The cart includes one or more caster wheels. A base platform is coupled to the one or more caster wheels. A leg assembly extends between the base platform and a top platform. The top platform comprises a plurality of separator bars spaced apart and co-extending with one another such that a plurality of rows are defined between the plurality of separator bars. Each row of the plurality of rows being sized to receive the one or more components of the conduit bender. A plurality of rollers extend between neighboring separator bars in each row of the plurality of rows. The plurality of rollers rotatably coupled to the neighboring separator bars.

In accordance with another embodiment, a method of using a cart for transferring one or more components of a conduit bender. The cart includes one or more caster wheels. A base platform coupled to the one or more caster wheels. A leg assembly extending between the base platform and a top platform. The method includes positioning the cart adjacent to the conduit bender. The method further includes removing a first component of the one or more components from the conduit bender. The method further includes receiving the first component of the one or more components into a first row of a plurality of rows of the top platform. The plurality of rows are defined between neighboring separator bars of a plurality of separator bars spaced apart from one another. The method further includes sliding the first component of the one or more components along the first row of the plurality of rows with a plurality of rollers extending across neighboring separator bars.

These and other features, aspects and advantages of the present carts and associated methods of use will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present carts and associated methods, including the best mode of making and using the present systems and methods, directed to one of ordinary skill in the art, is set forth in the specification, which makes reference to the appended figures, in which:

FIG. 1 illustrates a perspective view of a system having a cart and a conduit bender in accordance with embodiments of the present disclosure;

FIG. 2 illustrates a perspective view of a system having a cart and a conduit bender in accordance with embodiments of the present disclosure;

FIG. 3 illustrates a perspective view of a system having a cart and a conduit bender in accordance with embodiments of the present disclosure;

FIG. 4 illustrates a perspective view of an exemplary cart in accordance with embodiments of the present disclosure;

FIG. 5 illustrates a top view of an exemplary cart in accordance with embodiments of the present disclosure;

FIG. 6 illustrates a cross-sectional view of a single row of a top platform of a cart in accordance with embodiments of the present disclosure;

FIG. 7 illustrates a perspective view of an exemplary cart having one or more telescopic legs and a jack assembly in accordance with embodiments of the present disclosure;

FIG. 8 illustrates a side view of the exemplary cart shown in FIG. 7 in accordance with embodiments of the present disclosure;

FIG. 9 illustrates a perspective view of a having a scissor lifting assembly in accordance with embodiments of the present disclosure;

FIG. 10 illustrates a perspective view of a cart having a scissor lifting assembly with a top platform removed for clarity, in accordance with embodiments of the present disclosure;

FIG. 11 illustrates a cross-sectional side view of the cart shown in FIG. 9 having a scissor lifting assembly in accordance with embodiments of the present disclosure; and

FIG. 12 illustrates a flow diagram of a method of using a cart for transferring one or more components of a conduit bender, in accordance with embodiments of the present disclosure.

### DETAILED DESCRIPTION

Reference now will be made in detail to embodiments of the present carts and associated methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, terms of approximation, such as “generally,” “substantially,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

In general, the present subject matter is related to exemplary carts and methods of use for transferring one or more components of a conduit bender. For example, the conduit bender (or tube bender) may be used for plastically deforming metal tubes (e.g., conduits) into having a curvature or arc. In particular, the conduit bender may be a machine powered conduit bender (such as via one or more hydraulic actuators). Machine powered benders are capable of bending larger diameter tubes without a user applied force. Such benders often include a shoe having a defined arc, a follow bar, and a hydraulic actuator. In operation, the large diameter tube may be coupled to the shoe and follow bar, and the hydraulic actuator may apply a force to plastically deform (or permanently bend) the tube around the shoe. Many machine operated benders include one or more interchangeable components (such as shoes and/or follow bars) depending on the size of the tube to be bent, desired curve radius, or other factors. For example, the shoe and follow bar having a first size may be removed from the machine operated bender and replaced with a shoe and follow bar having a second size.

Particularly, as described herein, the present subject matter is related to a cart and associated method of use for transferring one or more components of the conduit bender (such as one or more shoes or follow bars). The cart may be provide means for easily transporting the one or more components of the machine powered conduit bender without requiring much force or exerted effort by the operator. The cart may include means for securing and simultaneously holding multiple shoes and/or follow bars of various sizes, such that the cart facilitates the removal and replacement of a first shoe and follow bar of a first size with a second shoe and follow bar of a second size. For example, the cart may be moved (e.g., via one or more caster wheels) to a position adjacent the conduit bender. Subsequently, one or more first components may be removed from the conduit bender and set on the cart, which can then be easily moved as needed.

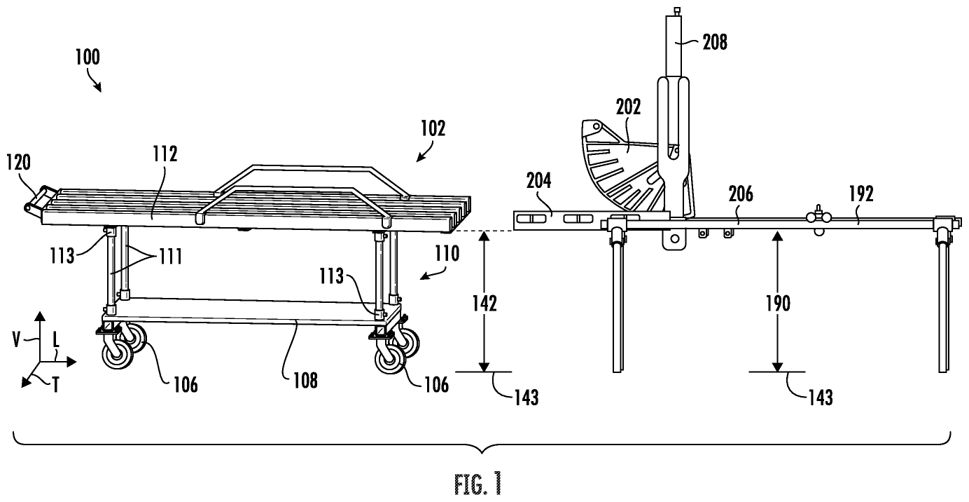

Referring now to FIGS. 1 through 3, an exemplary system 100 is illustrated. The system 100 includes a cart 102 positioned adjacent a conduit bender 200 on a support surface (e.g., the ground or floor across which the cart 102 may traverse). The conduit bender 200 may be a machine powered conduit bender having a shoe 202 and a follow bar 204 removably coupled to a frame 206 of the conduit bender 200. The shoe 202 and the follow bar 204 may be interchangeable with other shoes and follow bars having different sizes. For example, the cart 102 may simultaneously hold multiple shoes and follow bars of various sizes, such that the cart 102 may be used for facilitating a swap out the shoe 202 and follow bar 204 for alternative sizes. Additionally, the conduit bender 200 may include one or more hydraulic actuators 208 powered by a hydraulic pump for actuating the shoe 202 and/or the follow bar 204 for forming curvatures in large diameter tubes (e.g., conduits).

In many embodiments, the cart 102 may include one or more caster wheels 106, a base platform 108, a leg assembly 110 having one or more interchangeable legs 111 or legs 111, and a top platform 112. In exemplary embodiments, the one or more legs 111 may be interchangeable with legs having a different length. For example, the one or more legs 111 may be removably coupled to both the base platform 108 and the top platform 112 via one or more joints 113 (such as clamps, threaded couplings, or other suitable means for removably coupling the legs to the platforms 108, 112). As discussed below in more detail, the top platform 112 may be configured to securely hold multiple shoes and follow bars of various sizes (all compatible to be installed in the conduit bender 200). In operation, as illustrated in FIGS. 1 through 3 collectively, the cart 102 may be moved (e.g., via the caster wheels 106) to a position adjacent the conduit bender 200. The height (e.g., vertical height) of the top platform 112 may be adjusted (e.g., increased or decreased) by moving the leg assembly 110. For example, the top platform 112 may be adjusted to a similar (or equal) height as the shoe 202 on the conduit bender 200. Once the cart 102 is positioned in close proximity to the conduit bender 200 (e.g., directly adjacent) and the height of the top platform 112 is adjusted, the shoe 202 and follow bar 204 may be removed from the conduit bender 200 and secured to the top platform 112 (as shown in FIGS. 1 through 3). Subsequently, a separate shoe and follow bar of a different size (or the same size) may be removed from the cart 102 and installed in the conduit bender 200. In this way, the cart 102 may advantageously facilitate the transfer, removal, and installation of one or more components from the conduit bender 200 without requiring strenuous movement from an operator.

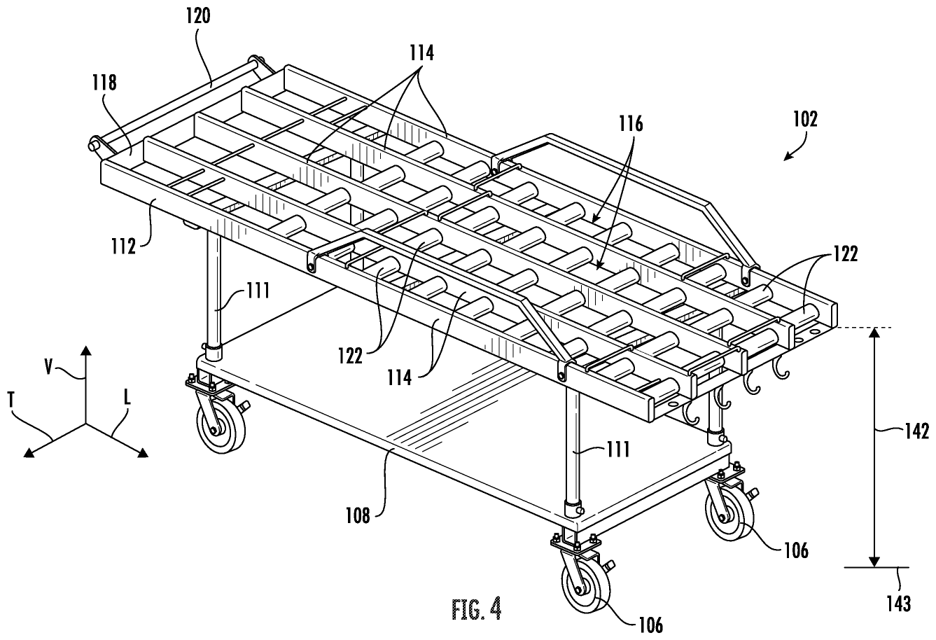

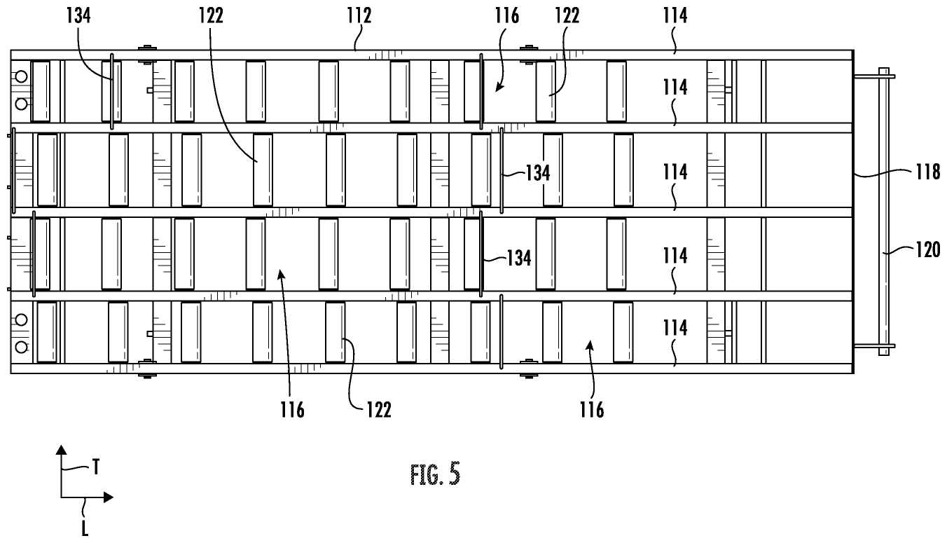

Referring now to FIGS. 4 through 11, a cart 102 for transferring one or more components of a conduit bender 200 is illustrated, in accordance with embodiments of the present disclosure. As shown, the cart 102 defines a longitudinal direction L, a vertical direction V, and a transverse direction T, each of which is mutually perpendicular, such that an orthogonal coordinate system is generally defined.

In many embodiments, the cart 102 may include one or more caster wheels 106 disposed in rotatable connection with a support surface, which allows the cart 102 to travel between destinations. The support surface may be the ground, floor, or other surface that supports the cart and is in contact with the caster wheels 106. In many embodiments, the caster wheels 106 may be swivel caster wheels, such that they can rotate in any direction, which allows the cart 102 to travel in any direction along the support surface (e.g., in any direction along the longitudinal-transverse plane). In particular embodiments, the cart 102 may include four caster wheels 106 disposed at, and coupled to, the four corners of a base platform 108 (which may be generally rectangularly shaped in some embodiments). Although exemplary embodiments of the cart 102 include four caster wheels disposed at the corners of the base platform 108 (which advantageously equally distributes the weight of the cart 102 on the caster wheels 106), it should be appreciated that the cart 102 may include any number of caster wheels 106 (such as 1, 2, 3, 4, 5, 6, or up to 10), and the present subject matter should not be limited to any particular number of caster wheels unless specifically recited in the claims.

In many embodiments, the base platform 108 and the top platform 112 may be generally rectangularly shaped (with the top platform 112 being larger than the base platform 108). For example, the base platform 108 and the top platform 112 may extend generally parallel to one another along the longitudinal-transverse plane.

Additionally, the cart 102 may include a leg assembly 110 extending between the base platform 108 and a top platform 112. The caster wheels 106 may be coupled to the base platform 108, and the leg assembly 110 may extend between the base platform 108 and the top platform 112. In the embodiment shown in FIGS. 4-10, the leg assembly 110 may include legs 111, with each leg extending generally vertically (e.g., in the vertical direction). For example, each leg 111 may extend generally perpendicularly to both the top platform 112 and the base platform 108. Particularly, each leg 111 may extend generally vertically between the base platform 108 and the top platform 112 and may be disposed at a respective corner of the base platform 108. For example, in many embodiments, both the base platform 108 and the top platform 112 may be generally rectangularly shaped (thus having four corners), and a leg 111 may extend between the base platform 108 and the top platform 112 at each corner (thereby uniformly distributing the weight of the top platform 112 among the leg assembly 110. In exemplary embodiments, as discussed below in more detail, the leg assembly 110 may advantageously be movable to adjust a height of the top platform 112 (e.g., a vertical height of the top platform 112).

In exemplary embodiments, the top platform 112 of the cart 102 may be configured to securely hold one or more components of the conduit bender 200 (such as one or more shoes and/or follow bars). For example, the top platform 112 may include a plurality of separator bars 114 spaced apart and co-extending with one another such that a plurality of rows 116 are defined between the plurality of separator bars 114. For example, each separator bar 114 may extend generally longitudinally (e.g., in the longitudinal direction L) and may be spaced apart (e.g., transversely spaced apart) from a neighboring separator bar 114, such that a row 116 is defined between the neighboring separator bars 114. In many embodiments, each separator bar 114 of the plurality of separator bars 114 may extend generally longitudinally from a first side of a forward frame 118, and a push handle 120 may extend from a second side of the forward frame 118 (e.g., opposite the plurality of separator bars 114). For example, the push handle 120 may couple to the top platform 112 and extend outwardly therefrom. In many implementations, an operator may apply a steering force to the push handle 120 to move the cart 102 as desired.

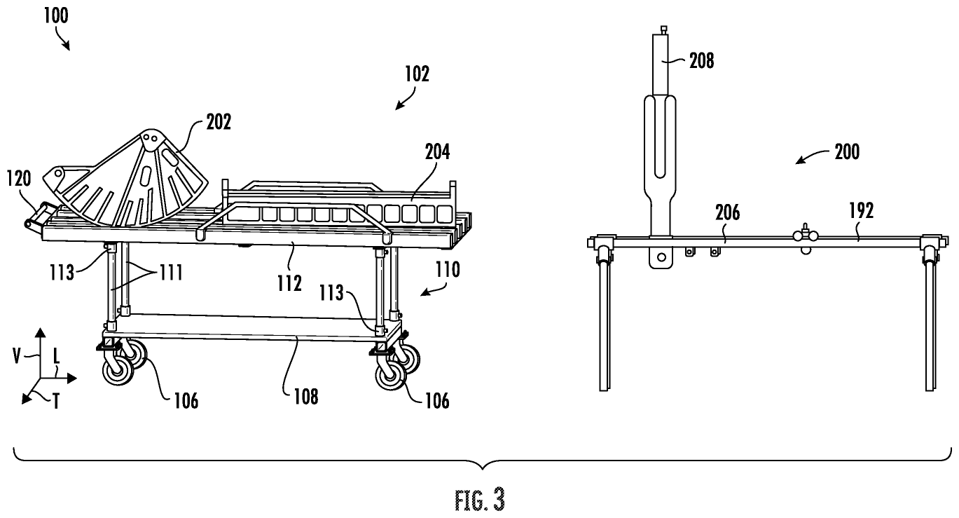

In exemplary embodiments, each row 116 of the plurality of rows 116 may be sized to receive the one or more components of the conduit bender 200. For example, these components may include one or more shoes and/or follow bars (such as the shoe 202 and follow bar 204 shown in FIGS. 1 through 3). In particular, each row 116 may be sized to receive and securely both a shoe and a follow bar (See FIG. 3 having a shoe and follow bar disposed in a row 116). In many embodiments, a plurality of rollers 122 may extend between neighboring separator bars 114 in each row 116 of the plurality of rows 116. For example, each roller 122 of the plurality of rollers may extend from a first separator bar, across a row 116, to a second separator bar (that directly neighbors the first separator bar). Each roller 122 of the plurality of rollers 122 may be rotatably coupled to both the neighboring separator bars 114 to which the roller 122 is disposed between. the plurality of rollers rotatably coupled to the neighboring separator bars.

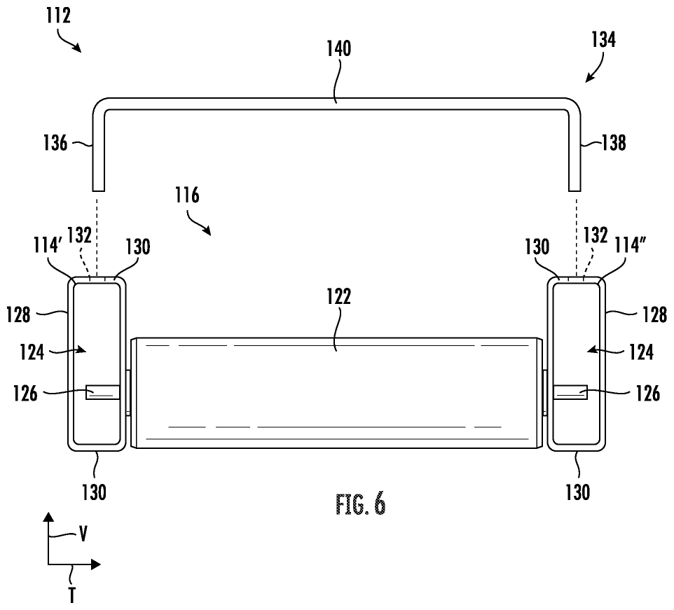

Referring now specifically to FIG. 6, an enlarged cross-sectional view of a single row 116 of the top platform 112 is illustrated. Particularly, FIG. 6 illustrates how a single roller 122 is coupled to neighboring separator bars 114′ and 114″ within a row 116, which may be representative of how each roller 122 of the plurality of rollers 122 is coupled in the respective rows 116. Each roller 122 may be generally cylindrically shaped. Additionally, each roller 122 may be translationally fixed in place within the respective row 116 but be free to rotate about the transverse axis T. Accordingly, in operation, one or more components may be slid along the plurality of rollers 122 within a row 116 to be moved in the longitudinal direction without requiring the operator to bear the weight of the one or more components. In many embodiments, as shown, the separator bars 114 may be generally rectangularly shaped and may include a hollow interior 124. For example, each of the separator bars 114 may include side walls 128 and end walls 130. The roller(s) 122 may include a pin portion 126 that extends through a side wall 128 of the separator bar 114 into the hollow interior 124.

Additionally, in many embodiments, as best shown in FIG. 6, each separator bar 114 of the plurality of separator bars 114 may define at least one aperture 132. For example, the at least one aperture may be defined in an end wall 130 (such as the vertically uppermost end wall 130 of the separator bar 114). In particular embodiments, a cross bar 134 may be removably coupled to, and extending between the at least one aperture 132 of a first separator bar 114′ of the plurality of separator bars and the at least one aperture 132 of a second separator bar 114″ of the plurality of separator bars (with the first separator bar 114′ and the second separator bar 114″ neighboring one another). for example, the cross bar 134 may extend generally along the transverse direction T across the row 116 (e.g., from a first separator bar to a second separator bar. Particularly, the cross bar 134 may include a first vertical portion 136 extending along the vertical direction V, through the at least one aperture 132 of a first separator bar 114′, and into the hollow interior 124. Similarly, the cross bar 134 may include a second vertical portion 138 extending along the vertical direction V, through the at least one aperture 132 of a second separator bar 114″, and into the hollow interior 124. Additionally, as shown, the cross bar may further include a transverse portion 140 extending along the transverse direction T between the first vertical portion 138 and the second vertical portion 138. In operation, the cross bar 134 may advantageously preventing the one or more components of the conduit bender 200 from sliding on the plurality of rollers 122 during movement of the cart 102. For example, once a component is positioned within a row 116 of the cart 102, the cross bar 134 may be inserted into place, thereby preventing movement of the component, and securing the component, within the row 116.

In exemplary embodiments, the leg assembly 110 may be movable to adjust a height 142 of the top platform 112, with the height 142 being measured along the vertical direction V between the support surface 143 (e.g., the ground or floor) and the top platform 112. For example, the leg assembly 110 may be movable (such as slidable or adjustable) to alter or change a height (e.g., a vertical height) of the top platform 112.

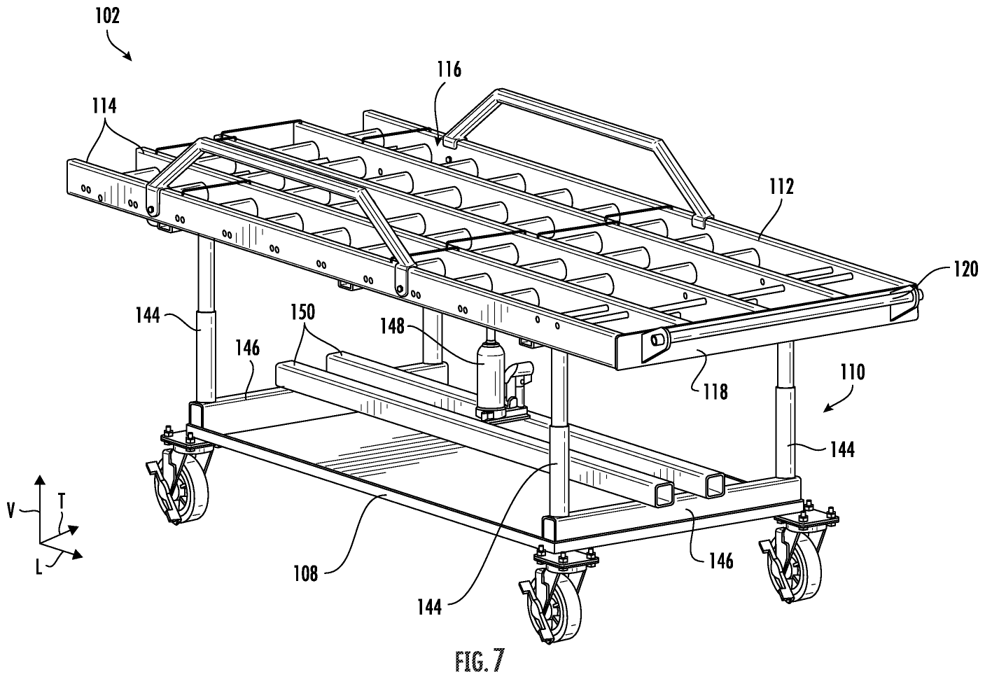

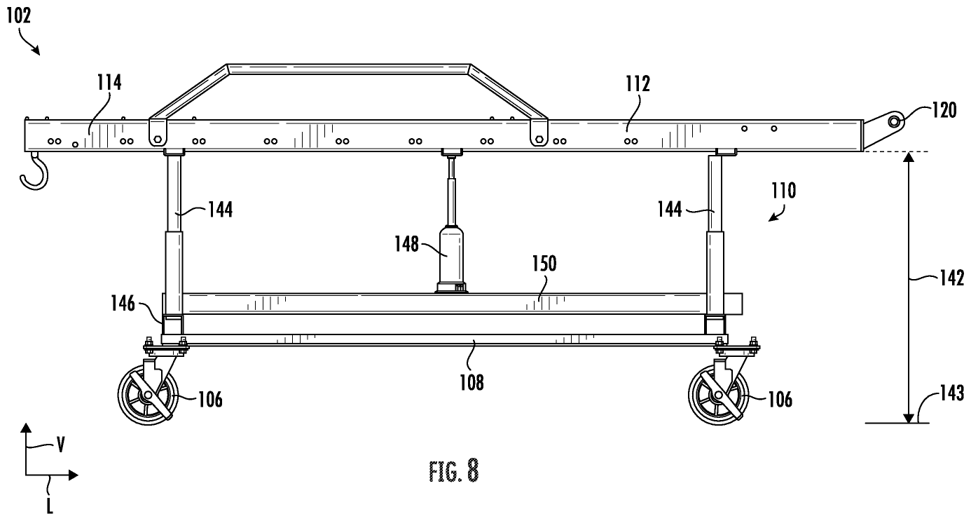

For example, FIGS. 7 and 8 the leg assembly 110 may include one or more telescoping legs 144 extending between the base platform 108 and the top platform 112. In exemplary embodiments, the one or more telescoping legs 144 may be movable to adjust a height 142 of the top platform 112. In particular embodiments, the leg assembly 110 of the cart 102 may include four telescoping legs 144 disposed at, and coupled to, the four corners of a base platform 108. For example, each telescoping leg 144 may be coupled to an opposite side of the base platform 108 as a respective caster wheel 106. Although exemplary embodiments of the cart 102 include four telescoping legs 144 (which advantageously equally distributes the weight of the cart top platform on the telescopic legs 144), it should be appreciated that the cart 102 may include any number of telescoping legs 144 (such as 1, 2, 3, 4, 5, 6, or up to 10), and the present subject matter should not be limited to any particular number of telescopic legs unless specifically recited in the claims.

In many embodiments, one or more support bars 146 may extend along the base platform 108. For example, the support bar may extend along an edge of the base platform 108 (e.g., along a portion of the perimeter). In exemplary embodiments, as shown, the one or more support bars 146 may extend in the transverse direction T and may provide additional structural support for the leg assembly 110.

In various embodiments, the leg assembly 110 further includes a jack assembly 148 extending between the base platform 108 and the top platform 112 such that operation of the jack assembly 148 causes the telescoping legs 144 to extend thereby adjusting the height of the top platform 112. In particular embodiments, the leg assembly 110 may include cross supports 150 extending longitudinally (e.g., along the longitudinal direction L) between the support bars 146. In such embodiments, the jack assembly may extend (e.g., vertically) between the cross supports 150 and the top platform 112.

In some implementations, the jack assembly 148 may be a mechanical jack that employs a screw and a threaded tube. In such embodiments, the screw may be manually turned to adjust the height of the top platform 112. In other embodiments, the jack assembly 148 may be a hydraulic jack. In such embodiments, the jack assembly may include a hydraulic pump connected to the hydraulic jack such that operation of the pump raises and lowers the top platform 112.

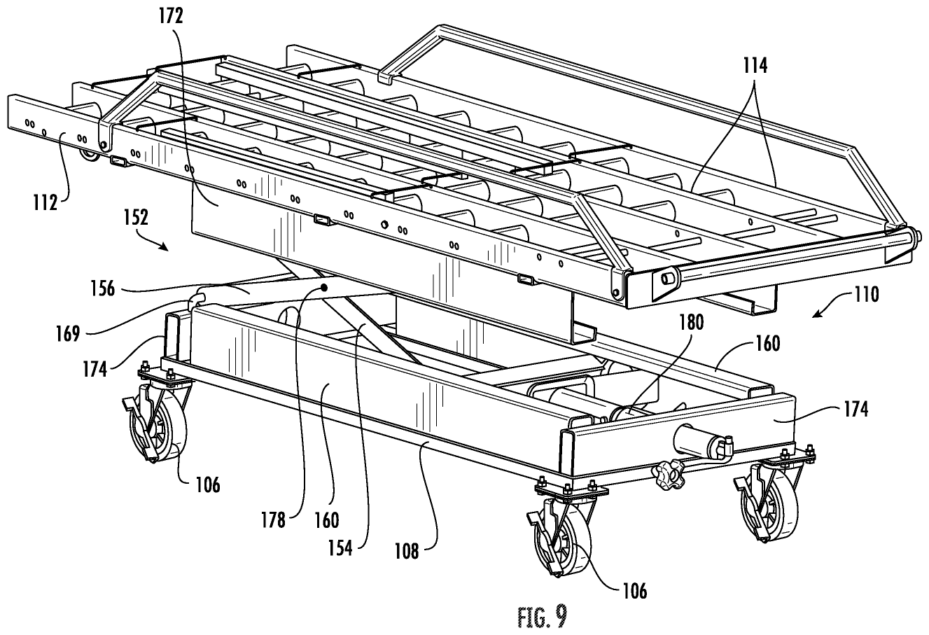

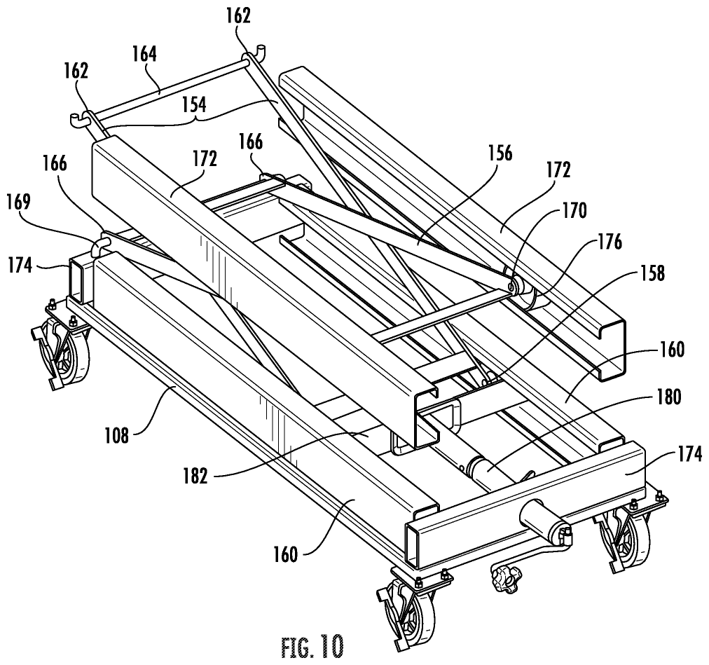

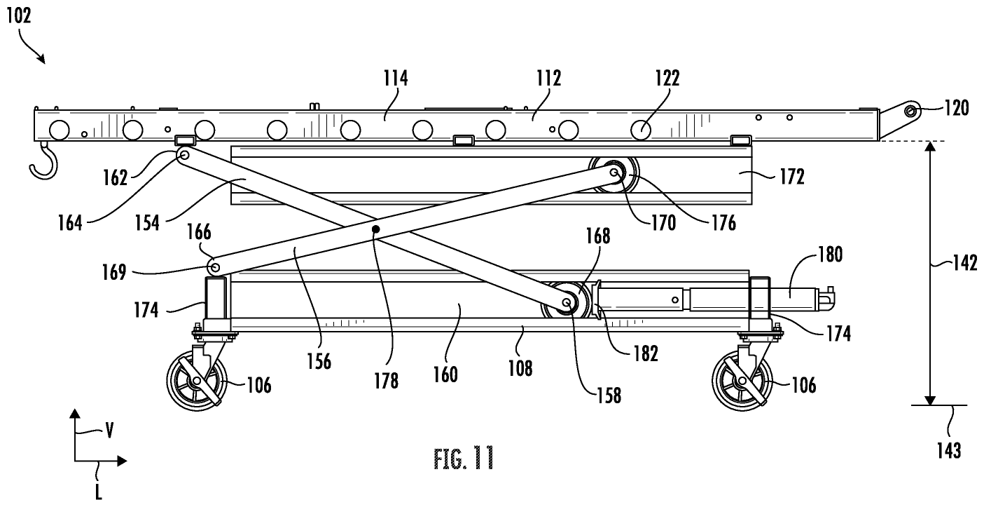

In other embodiment, as shown in FIGS. 9 through 11, the leg assembly 110 may be a scissor lifting assembly 152 capable of moving in order to adjust the height 142 of the top platform 112. For example, FIG. 9 illustrates a perspective view of the cart 102 having a scissor lifting assembly 152, FIG. 10 illustrates a perspective view of the cart 102 having a scissor lifting assembly 152 with the top platform 112 removed for clarity, and FIG. 11 illustrates a cross-sectional view of a cart 102 having a scissor lifting assembly 152, in accordance with embodiments of the present disclosure.

As shown in FIGS. 9 through 11, the scissor lifting assembly 152 may include a first pair of scissor legs 154 and a second pair of scissor legs 156. For example, the first pair of scissor legs 154 may extend from a first end 158 movably coupled to a first track assembly 160 disposed on the base platform 108 and a second end 162 fixedly coupled to a first mounting bar 164 disposed on the top platform 112. The mounting bar 164 may extend along the transverse direction T and may be fixedly coupled to the top platform 112, and the second ends 162 of the first pair of scissor legs 154 may be fixedly coupled to the mounting bar 164, such that movement of the scissor legs 154 directly alters the height 142 of the top platform 112. The first pair of scissor legs 154 may be movably coupled to the first track assembly 160 via wheels 168. The wheels may be housed within the first track assembly 160 such that they are restricted to movement in the longitudinal direction L. For example, the wheels 168 may be free to rotate, thereby moving the first end 158 in the longitudinal direction and altering the position of the second end 162, thereby altering the height 142 of the top platform 112.

Similarly, the second pair of scissor legs 156 may extend from a first end 166 fixedly coupled to a second mounting bar 169 disposed on the base platform 108 to a second end 170 movably coupled to a second track assembly 172. As shown, the second track assembly 172 may be fixedly coupled to the top platform 112. The second pair of scissor legs 156 may be movably coupled to the second track assembly 172 via wheels 176. The wheels 176 may be housed within the second track assembly 172 such that they are restricted to movement in the longitudinal direction L. For example, the wheels 176 may be free to rotate within the track assembly 172, thereby altering the height 142 of the top platform 112.

The mounting bar 169 may extend along the transverse direction T and may be fixedly coupled to the base platform 108, and the first ends 166 of the second pair of scissor legs 156 may be fixedly coupled to the mounting bar 169, such that movement of the scissor legs 156 directly alters the height 142 of the top platform 112. In some embodiments, as shown, the cart 102 may further include end bars 174 extending in the transverse direction T along a portion of the perimeter of the base platform 108. In such embodiments, the mounting bar 169 may be coupled to one of the end bars 174. The end bars 174 and the first track assembly 160 may collectively extend around the entire perimeter of the base platform 108.

In many embodiments, the first pair of scissor legs 154 and the second pair of scissor legs 156 may be pivotably coupled to one another with one or more pivot pins 178. The one or more pivot pins 178 may pivotably couple the pairs of scissor legs 154, 156 to one another, such that they rotate relative to each other at the junction (or intersection) of the pairs of scissor legs 154, 156.

In exemplary embodiments, the scissor lifting assembly 152 may include a jack assembly 180 mounted to the base platform 108. The jack assembly 180 may extend to a push plate 182 in operable communication with the first end 158 of the first pair of scissor legs 154 such that operation of the jack assembly 180 adjusts a height 142 of the top platform 112. For example, the jack assembly 180 may extend through an end bar 174, along the base platform 108, to a push plate 182. The push plate 182 may directly contact the wheels 168, such that operation of the jack assembly 180 moves the push plate 182 and the wheels 168, thereby altering the height 142 of the top platform 112.

In some implementations, the jack assembly 180 may be a mechanical jack that employs a screw and a threaded tube. In such embodiments, the screw may be manually turned to move the scissor lifting assembly and adjust the height of the top platform 112. In other embodiments, the jack assembly 180 may be a hydraulic jack. In such embodiments, the jack assembly 180 may include a hydraulic pump connected to the hydraulic jack such that operation of the pump raises and lowers the top platform 112.

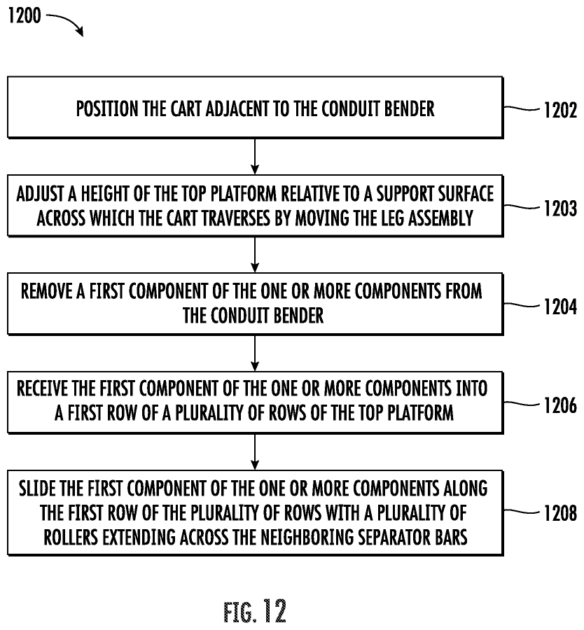

Referring now to FIG. 12, a flow diagram of one embodiment of a method 1200 of a cart (such as the cart 102 described above with reference to FIGS. 1 through 15) for transferring one or more components of a conduit bender is illustrated in accordance with aspects of the present subject matter. Although FIG. 12 depicts steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure.

In many embodiments, cart according to the method 1200 may include one or more caster wheels, a base platform coupled to the one or more caster wheels, a leg assembly extending between the base platform and a top platform. For example, in exemplary embodiments, the cart according to the method 1200 may be the cart 102 described above with reference to FIGS. 1 through 15.

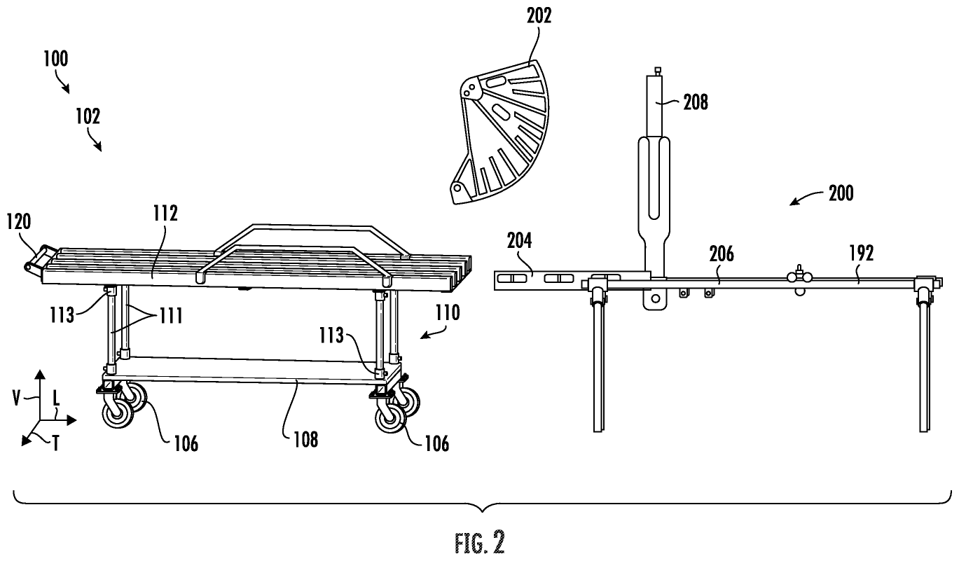

The method 1200 may include a step 1202 (such as an initial step) of positioning the cart 102 adjacent to a conduit bender 200 (as shown in FIGS. 1 through 2). For example, the cart 102 may be positioned directly next to the conduit bender 200 (e.g., in contact with the conduit bender 200), in order to minimize the distance between the cart 102 and the conduit bender 200 before loading components of the conduit bender on to the cart.

In various embodiments, the method 1200 may further include a step 1203 of adjusting the height 142 of the top platform 112 relative to a support surface across which the cart 102 traverses by moving the leg assembly 110. For example, the support surface may be the ground or floor, with which the one or more caster wheels 106 makes contact, and along which the caster wheels 106 may roll to move the cart 102. The height (e.g., vertical height) of the top platform 112 may be adjusted by moving the leg assembly 110. For example, in some implementations, the height 142 of the top platform 112 may be adjusted to be within about 10% (e.g., plus or minus 10%) of a table height 190 of the conduit bender 200 (FIG. 1). In other implementations, the height 142 of the top platform 112 may be adjusted to be within about 5% (e.g., plus or minus 5%) of the table height 190 of the conduit bender 200. In particular implementations, the height 142 of the top platform 112 may be adjusted to match (i.e., equal) the table height 190 of the conduit bender 200. The table height 190 of the conduit bender 200 may be measured between the support surface 143 (e.g., the ground or floor) and the top platform 192 of the conduit bender 200. As should be appreciated, the conduit bender 200 shown and described herein may be one of many types of conduit benders (which may have varying top platform heights), and the exemplary cart 102 described herein having height adjusting capabilities may be utilized alongside any type of conduit bender having any top platform height. For example, adjusting the height 142 of the top platform 112 of the cart 102 may advantageously allow the cart 102 to be used alongside any type of conduit bender (having any table height).

In many embodiments, the method 1200 may further include a step 1204 of removing a first component of the one or more components from the conduit bender 200. The one or more components may be a shoe 202 and/or a follow bar 204 of the conduit bender 200. The first component may be either the shoe 202 or the follow bar 204 but is preferably the shoe 202 in exemplary implementations.

In various embodiments, the method 1200 may further include a step 1206 of receiving the first component of the one or more components into a first row 116 of a plurality of rows 116 of the top platform 112. Each row 116 of the top platform 112 may be defined between neighboring separator bars 114 of a plurality of separator bars spaced 114 apart from one another. In many embodiments, the row 116 may be sized to receive the one or more components from the conduit bender. For example, in exemplary embodiments, each row 116 may be sized to hold both a shoe 202 and a follow bar 204 of a specified size, such that multiple shoes and follow bars in various sizes may be held within each row 116 of the cart 102 simultaneously.

In exemplary embodiments, the method 1200 may further include a step 1208 of sliding the first component of the one or more components along the first row 116 of the plurality of rows 116 with a plurality of rollers 122 extending across the neighboring separator bars 114′, 114″. For example, once the component (such as the shoe) is removed from the conduit bender 200, it may be rested on the rollers 122 within a row 116. At which point, the operator may apply a force (e.g., a force in the longitudinal direction L) to the component to slide the component within the row 116. In this way, the plurality of rollers 122 advantageously allows the operator to shift the location of the component within the row without having to bear the weight of the component.

Additionally, the method 1200 above may be repeated for a second component of the conduit bender 200 (such as a shoe 202 or follow bar 204). For example, the method 1200 may further include removing a second component of the one or more components from the conduit bender 200, receiving the second component of the one or more components into the first row 116 of a plurality of rows of the top platform 112, and sliding the first component of the one or more components along the first row 116 of the plurality of rows 116 with the plurality of rollers 122. In exemplary implementations, the first component may be a shoe 202, which is removed from the conduit bender and placed on the first row 116 of the cart 102. Subsequently, a follow bar 204 may be removed from the conduit bender 200 and placed on the same row 116 with the shoe 202.

In some embodiments, the method 1200 may further include a step of connecting a cross bar 134 into the at least one aperture 132 of neighboring separator bars 114′, 114″ of the plurality of separator bars 114 such that the cross bar 134 extends across the first row 116 of the plurality of rows 116 defined by the neighboring separator bars 114′, 114″. For example, in many implementations, the cross bar 134 may be installed after a component (such as a shoe or follow bar) is placed in the row 116, in order to prevent unwanted movement of the component within the row 116 while the cart 102 is being moved.

For example, in some embodiments, as shown and described above with reference to FIGS. 7 and 8, the leg assembly 110 may include one or more telescoping legs 144 extending between the base platform 108 and the top platform 112. the one or more telescoping legs 144 may be vertically movable to adjust a height of the top platform 112. Additionally, in such embodiments, the method may further include applying a force (such as a vertically oriented force) with a jack assembly 148 to the top platform 112 to adjust a height 142 of the top platform 112. the jack assembly 148 is disposed on the base platform 108 and extends to the top platform 112. In particular, applying the force with the jack assembly 148 will cause the one or more telescoping legs 144 to extend, thereby altering the height of the top platform 112 relative to the support surface.

In other embodiments, as shown and described above with reference to FIGS. 9 through 11, the leg assembly 110 may be a scissor lifting assembly 152. In such embodiments, the method 1200 may further include a step of applying a force (such as a force in the longitudinal direction L) with a jack assembly 180 to the first pair of scissor legs 154 to adjust a height of the top platform 112. For example, the jack assembly 180 may be disposed on the base platform 108 and may extend to a push plate 182 in operable communication with the first end 158 of the first pair of scissor legs 154. For example, the push plate 182 may contact the wheels 168, such that movement of the push plate moves the wheels 168 within the first track assembly 160. In particular, the jack assembly 180 may extend through an end bar 174, along the base platform 108, to a push plate 182. The push plate 182 may directly contact the wheels 168, such that operation of the jack assembly 180 moves the push plate 182 (which rotates the wheels 168), thereby causing the scissor lifting assembly 152 to move which increases the height 142 of the top platform 112.

In various embodiments, leg assembly 110 may include a first set of legs (such as the legs 111) removably coupled to both the base platform 108 and the top platform 112, with each leg in the first set of legs having a first length (e.g., measured along the vertical direction V). For example, each leg in the first set of legs may be coupled to the base platform 108 and the top platform 112 via joints 113 (such as clamps, threaded couplings, or other suitable means for removably coupling the legs 111 to the platforms 108, 112). The method 1200 may further include an optional step of decoupling the first set of legs from the base platform 108 and the top platform 112. Once the first set of legs are removed from the base platform 108 and the top platform 112, the height 142 of the top platform 112 may be adjusted by replacing the first set of legs with a second set of legs having a different length. For example, the method 1200 may further include an optional step of coupling a second set of legs to the base platform 108 and the top platform 112 (e.g., via the joints 113), with each leg in the second set of legs having a second length that is different (e.g., longer or shorter) than the first length. In this way, each leg 111 of the cart 102 may be interchangeable or substitutable with another leg having a different length, in order to adjust the height 142 of the top platform 112 as desired.

As discussed hereinabove, the cart 102 described herein may include a top platform 112 that is advantageously height adjustable. This may allow the cart 102 to be used alongside a variety of different conduit benders having a variety of heights. Additionally, the height 142 of the top platform 112 to be adjusted based on operator preference, thereby increasing the ergonomics of the cart 102 and overall user comfort.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A cart for transferring one or more components of a conduit bender, the cart defining a longitudinal axis, a vertical axis, and a transverse axis, the cart comprising:
one or more caster wheels;
a base platform coupled to the one or more caster wheels; and
a leg assembly extending between the base platform and a top platform, the leg assembly being movable to adjust a height of the top platform, the top platform comprising a plurality of separator bars spaced apart and co-extending with one another such that a plurality of rows are defined between the plurality of separator bars, each row of the plurality of rows being sized to receive the one or more components of the conduit bender, a plurality of rollers extending between neighboring separator bars in each row of the plurality of rows, the plurality of rollers rotatably coupled to the neighboring separator bars.

2. The cart of claim 1, wherein each separator bar of the plurality of separator bars defines at least one aperture.

3. The cart of claim 2, further comprising a cross bar removably coupled and extending between the at least one aperture of a first separator bar of the plurality of separator bars and the at least one aperture of a second separator bar of the plurality of separator bars.

4. The cart of claim 1, wherein the leg assembly is a scissor lifting assembly, the scissor lifting assembly including a first pair of scissor legs and a second pair of scissor legs, the first pair of scissor legs extending from a first end movably coupled to a first track assembly disposed on the base platform and a second end fixedly coupled to a first mounting bar disposed on the top platform, the second pair of scissor legs extending from a first end fixedly coupled to a second mounting bar disposed on the base platform to a second end movably coupled to a second track assembly, and wherein the first pair of scissor legs and the second pair of scissor legs are pivotably coupled to one another with one or more pivot pins.

5. The cart of claim 4, wherein the scissor lifting assembly further includes a jack assembly mounted to the base platform, the jack assembly extending to a push plate in operable communication with the first end of the first pair of scissor legs such that operation of the jack assembly adjusts a height of the top platform.

6. The cart of claim 1, wherein the leg assembly includes one or more telescoping legs extending between the base platform and the top platform, the one or more telescoping legs movable to adjust a height of the top platform.

7. The cart of claim 6, wherein the leg assembly further includes a jack assembly extending between the base platform and the top platform such that operation of the jack assembly adjusts the height of the top platform.

8. The cart of claim 1, further comprising a push handle coupled to the top platform.

9. The cart of claim 1, wherein the leg assembly includes one or more interchangeable legs each removably coupled to both the base platform and the top platform via one or more joints.

10. A method of using a cart for transferring one or more components of a conduit bender, the cart comprising one or more caster wheels, a base platform coupled to the one or more caster wheels, a leg assembly extending between the base platform and a top platform, the method comprising:
positioning the cart adjacent to the conduit bender;
adjusting a height of the top platform relative to a support surface across which the cart traverses by moving the leg assembly;
removing a first component of the one or more components from the conduit bender;
receiving the first component of the one or more components into a first row of a plurality of rows of the top platform, the plurality of rows defined between neighboring separator bars of a plurality of separator bars spaced apart from one another;
sliding the first component of the one or more components along the first row of the plurality of rows with a plurality of rollers extending across the neighboring separator bars.

11. The method of claim 10, further comprising:
adjusting a height of the top platform to be within about 10% of a table height of the conduit bender.

12. The method of claim 10, wherein the leg assembly is a scissor lifting assembly, the scissor lifting assembly including a first pair of scissor legs and a second pair of scissor legs, the first pair of scissor legs extending from a first end movably coupled to a first track assembly disposed on the base platform and a second end fixedly coupled to a first mounting bar disposed on the top platform, the second pair of scissor legs extending from a first end fixedly coupled to a second mounting bar disposed on the base platform to a second end movably coupled to a second track assembly, wherein the first pair of scissor legs and the second pair of scissor legs are pivotably coupled to one another with one or more pivot pins.

13. The method of claim 12, further comprising:
Applying a force with a jack assembly to the first pair of scissor legs to adjust a height of the top platform, wherein the jack assembly is disposed on the base platform and extends to a push plate in operable communication with the first end of the first pair of scissor legs.

14. The method of claim 10, wherein the leg assembly includes one or more telescoping legs extending between the base platform and the top platform, the one or more telescoping legs movable to adjust a height of the top platform.

15. The method of claim 14, further comprising:
applying a force with a jack assembly to the top platform to adjust a height of the top platform, wherein the jack assembly is disposed on the base platform and extends to the top platform, and wherein applying the force with the jack assembly causes the one or more telescoping legs to extend.

16. The method of claim 10, further comprising:
removing a second component of the one or more components from the conduit bender;
receiving the second component of the one or more components into a first row of a plurality of rows of the top platform;
sliding the first component of the one or more components along the first row of the plurality of rows with the plurality of rollers.

17. The method of claim 16, wherein the first component is a shoe of the conduit bender and the second component is a follow bar of the conduit bender.

18. The method of claim 11, wherein each separator bar of the plurality of separator bars defines at least one aperture, and wherein the method further comprises:
connecting a cross bar to the at least one aperture of neighboring separator bars of the plurality of separator bars such that the cross bar extends across the first row of the plurality of rows defined by the neighboring separator bars.

19. The method of claim 10, wherein the leg assembly includes a first set of legs removably coupled to both the base platform and the top platform, wherein each leg in the first set of legs has a first length, and wherein the method comprises:
decoupling the first set of legs from the base platform and the top platform; and
coupling a second set of legs to the base platform and the top platform, each leg in the second set of legs having a second length that is different than the first length.
